(19) United States
(12) Patent Application Publication
(10) Pub. No.: US 2021/0397951 A1
(43) Pub. Date: Dec. 23, 2021

(54) DATA PROCESSING APPARATUS, DATA PROCESSING METHOD, AND PROGRAM

(71) Applicant: NIPPON TELEGRAPH AND TELEPHONE CORPORATION, Tokyo (JP)

(72) Inventors: Akihiro CHIBA, Musashino-shi, Tokyo (JP); Shozo AZUMA, Musashino-shi, Tokyo (JP); Kazuhiro YOSHIDA, Musashino-shi, Tokyo (JP); Hisashi KURASAWA, Musashino-shi (JP); Naoki ASANOMA, Musashino-shi, Tokyo (JP); Tsutomu YABUUCHI, Musashino-shi, Tokyo (JP)

(73) Assignee: NIPPON TELEGRAPH AND TELEPHONE CORPORATION, Tokyo (JP)

(21) Appl. No.: 17/279,834

(22) PCT Filed: Sep. 17, 2019
(86) PCT No.: PCT/JP2019/036263

§ 371 Date: Mar. 25, 2021

(30) Foreign Application Priority Data
Sep. 28, 2018 (JP) 2018-184073

(51) Int. Cl. G06N 3/08; G06N 3/04

(52) U.S. Cl. CPC G06N 3/08; G06N 3/049

(57) ABSTRACT

A data processing apparatus according to a first aspect of the present invention includes: a first generation section that generates first input data in which first data related to a first phenomenon and second data related to a second phenomenon that is relevant to the first phenomenon are combined with first auxiliary data that is based on a missing data status in at least one of the first data and the second data; and a learning section that learns a model parameter of a prediction model, based on an error according to the first auxiliary data between output data outputted from the prediction model when the first input data is inputted into the prediction model, and each of the first data and the second data.

### TECHNICAL FIELD

The present invention relates to a technology of modeling a relationship between a plurality of phenomena.

### BACKGROUND ART

For example, in order to set a target of a health action such as the number of steps per day, it is required to model a relationship between time-series variations in the health action and time-series variations in a laboratory value obtained through health checks or an examination at a hospital.

Non-Patent Literature 1 discloses an example of a scheme of learning a relationship between two phenomena. While the scheme is effective for dense data such as images, effective learning cannot be achieved, for example, when data, such as medical health data, including missing values due to non-performance of measurement or errors in measurement is used as training data.

A scheme disclosed in Patent Literature 1 is among methods that perform learning by using data including missing values. Patent Literature 1 describes the scheme of learning time-series variations in one phenomenon, but does not describe a scheme of learning a relationship between two phenomena.

### CITATION LIST

### Patent Literature

Patent Literature 1: International Publication No. WO 2018/047655

### Non-Patent Literature

Non-Patent Literature 1: Masahiro Suzuki, Yutaka Matsuo, Multimodal Learning by Deep Generative Model, The 30th Annual Conference of the Japanese Society for Artificial Intelligence, 2016

### SUMMARY OF THE INVENTION

### Technical Problem

A technology is required that can model a relationship between two, or among three or more, phenomena by using data including a missing value.

The present invention has been made in view of the circumstances described above, and an object of the present invention is to provide a data processing apparatus, a data processing method, and a program that can model a relationship between a plurality of phenomena by using data including a missing value as training data.

### Means for Solving the Problem

In a first aspect of the present invention, a data processing apparatus includes: a first generation section that generates first input data in which first data related to a first phenomenon and second data related to a second phenomenon that is relevant to the first phenomenon are combined with first auxiliary data that is based on a missing data status in at least one of the first data and the second data; and a learning section that learns a model parameter of a prediction model, based on an error according to the first auxiliary data between output data outputted from the prediction model when the first input data is inputted into the prediction model, and each of the first data and the second data.

In a second aspect of the present invention, the first generation section generates the first auxiliary data including auxiliary data that is based on the missing data status in the first data and auxiliary data that is based on the missing data status in the second data.

In a third aspect of the present invention, the first generation section calculates a degree of missing data in each of the first data and the second data, selects data with the higher degree of missing data between the first data and the second data, and generates the first auxiliary data based on the missing data status in the selected data.

In a fourth aspect of the present invention, the first generation section generates the first auxiliary data, based on the missing data status in predetermined data between the first data and the second data.

In a fifth aspect of the present invention, the first generation section generates the first auxiliary data, based on the missing data status in predetermined data between the first data and the second data, and on a temporal relationship between the first phenomenon and the second phenomenon.

In a sixth aspect of the present invention, the prediction model is a neural network including an input layer, at least one intermediate layer, and an output layer, and one of the at least one intermediate layer includes a node that is affected by both the first data and the second data, and at least one of a node that is affected by the first data but is not affected by the second data and a node that is affected by the second data but is not affected by the first data.

In a seventh aspect of the present invention, the data processing apparatus further includes: a second generation section that generates second input data in which third data related to the first phenomenon and fourth data related to the second phenomenon are combined with second auxiliary data that is based on a missing data status in at least one of the third data and the fourth data; and a prediction section that inputs the second input data into the prediction model in which the learned model parameter is set, and obtains a predicted value corresponding to a missing value included in at least one of the third data and the fourth data.

In an eighth aspect of the present invention, the data processing apparatus further includes: a second generation section that generates second input data in which third data related to the first phenomenon and fourth data related to the second phenomenon are combined with second auxiliary data that is based on a missing data status in at least one of the third data and the fourth data; and a prediction section that inputs the second input data into the prediction model in which the learned model parameter is set, and obtains data outputted from an intermediate layer of the prediction model.

### Effects of the Invention

According to the first aspect of the present invention, since error calculation is performed according to the first auxiliary data, an error is calculated, with an effect of missing data excluded. Thus, a relationship between the two phenomena can be learned by using data including a missing value.

According to the second aspect of the present invention, an error is calculated, with effects of missing data in both the first data and the second data excluded. Thus, a relationship between the two phenomena can be effectively learned by using data including a missing value.

According to the third aspect of the present invention, for example, when there is bias in the number of missing data between the first data and the second data, a relationship between the two phenomena can be effectively learned.

According to the fourth aspect of the present invention, for example, learning is performed with emphasis placed on data related to a phenomenon with a higher degree of importance. Thus, a model parameter can be obtained that enhances accuracy in prediction for data related to the phenomenon with the higher degree of importance.

According to the fifth aspect of the present invention, for example, when there is a time lag between the first phenomenon and the second phenomenon, a relationship between the two phenomena can be effectively learned.

According to the sixth aspect of the present invention, the prediction model with high accuracy in prediction can be provided.

According to the seventh aspect of the present invention, a predicted value corresponding to a missing data portion can be obtained. Thus, analysis of data including a missing value, such as medical health data, can be correctly performed by interpolating the obtained predicted value into the medical health data.

According to the eighth aspect of the present invention, a feature can be obtained that represents a relationship between the first phenomenon and the second phenomenon.

In other words, according to the present invention, it is possible to provide a data processing apparatus, a data processing method, and a program that can model a relationship between a plurality of phenomena by using data including a missing value as training data.

### BRIEF DESCRIPTION OF DRAWINGS

FIG. 1 is a block diagram showing a data processing apparatus according to an embodiment.

FIG. 2 shows an example of an architecture of a prediction model according to the embodiment.

FIG. 3 is a diagram for describing an example of a method for generating input data, according to the embodiment.

FIG. 4 is a diagram for describing another example of the method for generating input data, according to the embodiment.

FIG. 5 is a flowchart showing learning processing according to the embodiment.

FIG. 6 is a flowchart showing prediction processing according to the embodiment.

FIG. 7 is a diagram for describing the prediction processing according to the embodiment.

FIG. 8 is a diagram for describing the prediction processing according to the embodiment.

FIG. 9 is a diagram for describing the prediction processing according to the embodiment.

FIG. 10 is a diagram for describing a method for generating auxiliary data, according to another embodiment.

FIG. 11 is a diagram for describing a method for generating auxiliary data, according to another embodiment.

FIG. 12 is a diagram for describing an example of a method for generating input data when there are a plurality of types of biomarkers, according to another embodiment.

FIG. 13 is a diagram for describing another example of the method for generating input data when there are a plurality of types of biomarkers, according to the another embodiment.

### DESCRIPTION OF EMBODIMENTS

Hereinafter, embodiments of the present invention will be described with reference to drawings. A data processing apparatus according to an embodiment learns a model representing a relationship between a first phenomenon and a second phenomenon that is relevant to the first phenomenon, by using data related to the first phenomenon and data related to the second phenomenon. The data processing apparatus can perform effective learning even when the data related to the first phenomenon and the data related to the second phenomenon that is relevant to the first phenomenon include missing data.

<Embodiment>

[Configuration]

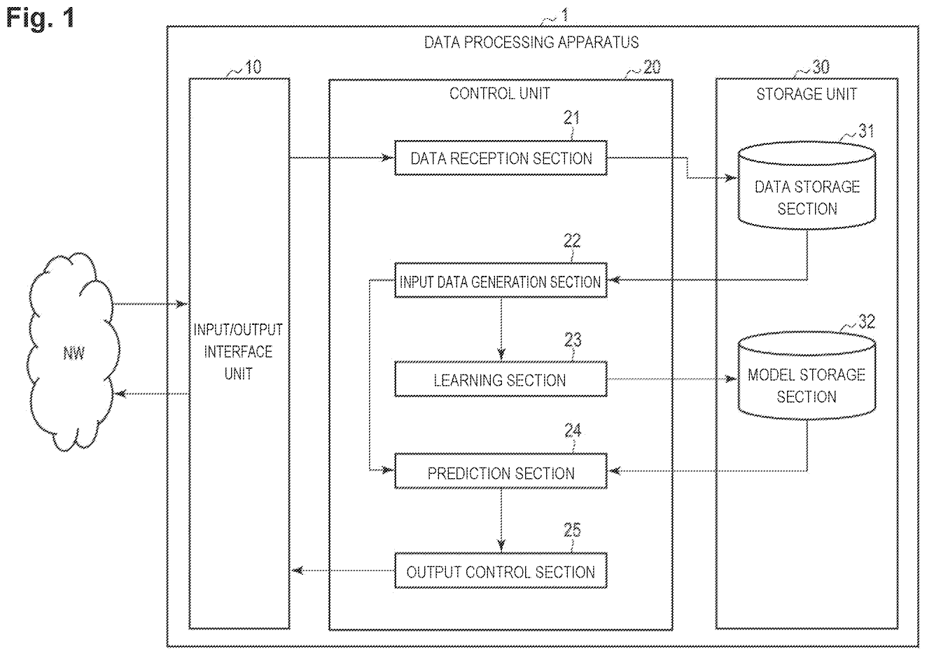

FIG. 1 schematically shows a data processing apparatus 1 according to an embodiment of the present invention. The data processing apparatus 1 is configured, for example, by using a computer such as a personal computer, a smartphone, or a server. In the example in FIG. 1, the data processing apparatus 1 includes an input/output interface unit 10, a control unit 20, and a storage unit 30.

In the present embodiment, it is assumed that the data processing apparatus 1 is implemented in a server and can communicate with an external apparatus via a communication network NW such as the Internet.

The input/output interface unit 10 includes connectors such as a LAN (Local Area Network) port and a USB (Universal Serial Bus) port. The input/output interface unit 10 is connected to the communication network NW by using, for example, a LAN cable, and transmits data to and receives data from the external apparatus via the communication network NW. Further, the input/output interface unit 10 is connected to a display device and an input device through a USB cable, and transmits data to and receives data from the display device and the input device. Note that the input/output interface unit 10 may include a wireless module such as a wireless LAN module or a Bluetooth(R) module.

The control unit 20 includes a hardware processor such as a CPU (Central Processing Unit) and a program memory such as a ROM (Read Only Memory), and controls constituent elements including the input/output interface unit 10 and the storage unit 30. The control unit 20 functions as a data reception section 21, an input data generation section 22, a learning section 23, a prediction section 24, and an output control section 25, by causing the hardware processor to execute a program stored in the program memory.

The storage unit 30 uses, for a storage medium, a nonvolatile memory that can be written to and read from at any time such as an HDD (Hard Disk Drive) or an SSD (Solid State Drive), and includes, as storage areas, a data storage section 31 and a model storage section 32.

The program may be stored in the storage unit 30, instead of the program memory of the control unit 20. In an example, the control unit 20 may download the program from an external apparatus provided on the communication network NW via the input/output interface unit 10, and may store the program in the storage unit 30. In another example, the control unit 20 may acquire the program from a detachable storage medium such as a magnetic disk, an optical disk, or a semiconductor memory, and may store the program in the storage unit 30.

The data reception section 21 receives data related to a health action of a user and data related to a biomarker of the user, and stores the received data in the data storage section 31. Hereinafter, the data related to the health action of the user will be referred to as health action data, and the data related to the biomarker of the user will be referred to as biomarker data. The health action of the user is an example of the first phenomenon, and the biomarker of the user is an example of the second phenomenon.

A biomarker refers to an indicator representing a health state of a biological object. Examples of the biomarker include blood pressure, pulse rate, heart rate, body weight, body fat percentage, blood glucose level, total cholesterol, neutral fat, uric acid level, an answer to a medical interview (questionnaire) at a hospital, and the like. The biomarker data may be acquired through measurement at home, or may be acquired through an examination (for example, a blood test or a urine test) at a hospital. A health action refers to an action affecting the biomarker. Examples of the health action include the number of steps, hours of sleep, calorie intake, and the like. The health action data can be acquired, for example, by using a wearable device such as a pedometer.

In the present embodiment, it is assumed that the health action data and the biomarker data are acquired every day. However, for example, if the biomarker data is acquired through an examination at a hospital, the biomarker data is not acquired on a day when the user does not visit the hospital. For such a reason, missing data may occur in the health action data in some cases. Missing data may also occur in the health action data for some reason such as non-performance of measurement. An interval between acquisitions of the data is not limited to one day, but may be, for example, one hour, one week, or the like.

The input data generation section 22 generates input data according to a design of a prediction model, from the health action data and the biomarker data stored in the data storage section 31. Specifically, the input data generation section 22 extracts health action data for a predetermined number of days from the health action data stored in the data storage section 31, extracts biomarker data for the predetermined number of days from the biomarker data stored in the data storage section 31, and generates auxiliary data based on a missing data status in each of the extracted health action data and biomarker data. The auxiliary data includes auxiliary data related to the health action data, and auxiliary data related to the biomarker data. Subsequently, the input data generation section 22 generates the input data by combining the extracted health action data and the extracted biomarker data with the generated auxiliary data.

At a stage of learning model parameters of the prediction model, the input data generation section 22 gives the generated input data to the learning section 23. Typically, the input data generation section 22 generates an input dataset including a plurality of subsets of input data, and gives the generated input dataset to the learning section 23. The input dataset can include input data including a missing value and input data including no missing value. At a stage of performing prediction by using the prediction model, the input data generation section 22 generates input data including missing data, and gives the generated input data to the prediction section 24.

The learning section 23 learns the model parameters of the prediction model by using the input data generated by the input data generation section 22. Specifically, the learning section 23 learns the model parameters of the prediction model, based on an error according to the auxiliary data between output data and each of the health action data and the biomarker data. Here, the output data is data outputted from the prediction model when the input data generated by the input data generation section 22 is inputted into the prediction model. The health action data and the biomarker data are extracted by the input data generation section 22. The auxiliary data is generated by the input data generation section 22. For example, the learning section 23 optimizes the model parameters such that the error is minimized.

The prediction section 24 obtains a predicted value corresponding to a missing value included in input data generated by the input data generation section 22, by using the learned prediction model (that is, the prediction model in which the model parameters learned by the learning section 23 is set). Specifically, the prediction section 24 inputs the input data into the learned prediction model, and obtains output data including the predicted value corresponding to the missing value, outputted from the learned prediction model.

The output control section 25 outputs the predicted value obtained by the prediction section 24. For example, the output control section 25 transmits the predicted value to an external apparatus (for example, a computer terminal used by a doctor) via the input/output interface unit 10.

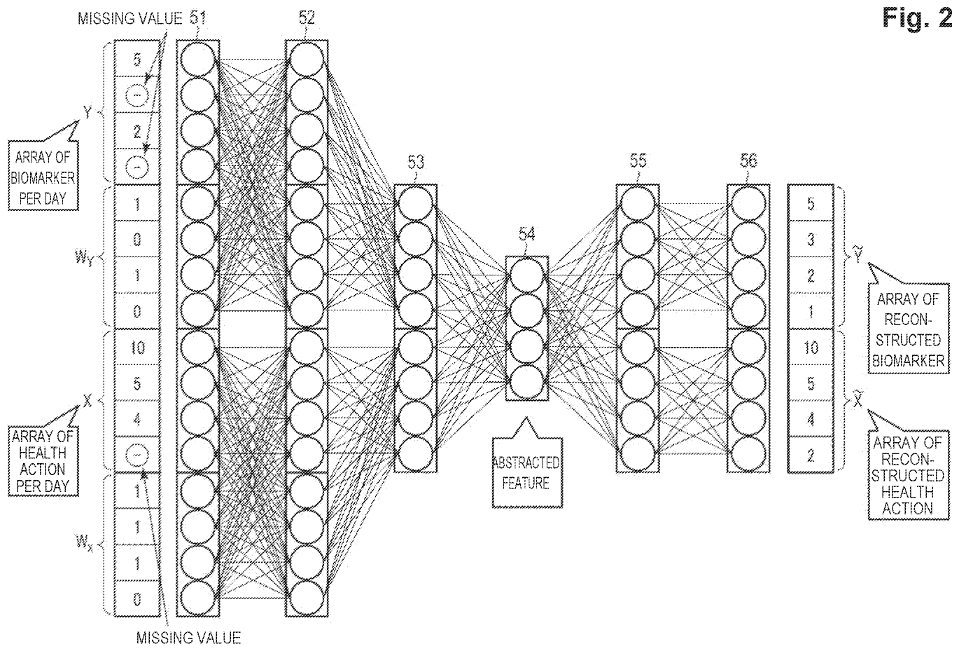

FIG. 2 schematically shows an example of an architecture of the prediction model according to the present embodiment. As shown in FIG. 2, the prediction model according to the present embodiment is a neural network including an input layer 51, four intermediate layers 52 to 55, and an output layer 56. The prediction model receives the health action data and the biomarker data as input and includes a network that reconstructs the health action data and a network that reconstructs the biomarker data. The networks share a portion (specifically, the intermediate layer 54) of the intermediate layers.

The input layer 51 has 16 dimensions, the intermediate layer 52 has 16 dimensions, the intermediate layer 53 has eight dimensions, the intermediate layer 54 has four dimensions, the intermediate layer 55 has eight dimensions, and the output layer 56 has eight dimensions. In the example in FIG. 2, the prediction model is an autoencoder.

When input data is represented by an array of 16 elements (a 16-by-1 matrix), the biomarker data is assigned to the first to fourth elements, the auxiliary data related to the biomarker data is assigned to the fifth to eighth elements, the health action data is assigned to the ninth to twelfth elements, and the auxiliary data related to the health action data is assigned to the thirteenth to sixteenth elements. In FIG. 2, an array X represents the health action data, an array Y represents the biomarker data, an array W_{X} represents the auxiliary data related to the health action data, and an array W_{Y} represents the auxiliary data related to the biomarker data.

The array W_{X} is generated based on the missing data status in the health action data. The array W_{Y} is generated based on the missing data status in the biomarker data. In the auxiliary data, a value “1” indicates that data is present (a non-missing value), and a value “0” indicates that data is absent (a missing value). A sign “-” shown in the input arrays denotes a missing value. In an actual array, for example, a value such as “0” is substituted into a missing-value portion. Second and fourth elements of the array Y are missing, and the array W_{Y} is generated accordingly in which first and third elements are “1” and second and fourth elements are “0”. Moreover, a fourth element of the array X is missing, and the array W_{X} is generated accordingly in which first to third elements are “1” and a fourth element is “0”.

When output data is represented by an array of eight elements (an 8-by-1 matrix), the biomarker data is assigned to the first to fourth elements, and the health action data is assigned to the fifth to eighth elements. An array Y˜ represents the biomarker data, and X˜ represents the health action data.

Arrays of the input layer 51, the intermediate layer 52, the intermediate layer 53, the intermediate layer 54, the intermediate layer 55, and the output layer 56 are denoted by Z₁, Z₂, Z₃, Z₄, Z₅, and Z₆, respectively. The arrays Z₁ to Z₆ are expressed as following formulas (1a) to (1f), respectively.

Z₁=(z_{1,1} z_{1,2} z_{1,3} z_{1,4} . . . z_{1,16})^{T} (1a)

Z₂=(z_{2,1} z_{2,2} z_{2,3} z_{2,4} . . . z_{2,16})^{T} (1b)

Z₃=(z_{3,1} z_{3,2} z_{3,3} z_{3,4} . . . z_{3,8})^{T} (1c)

Z₄=(z_{4,1} z_{4,2} z_{4,3} z_{4,4})^{T} (1d)

Z₅=(z_{5,1} z_{5,2} z_{5,3} z_{5,4} . . . z_{5,8})^{T} (1e)

Z₆=(z_{6,1} z_{6,2} z_{6,3} z_{6,4} . . . z_{6,8})^{T} (1f)

Here, a superscript “T” denotes transpose.

The array of each layer can be expressed by a recurrence formula such as a following formula (2).

Zᵢ₊₁=fᵢ(AᵢZᵢ+Bᵢ) (2)

Here, Aᵢ is a matrix of a weight parameter, Bᵢ is an array of a bias parameter, and fᵢ represents an activation function.

As an example, activation functions f₁, f₃, f₄, f₅ are linear combinations (simple perceptron) such as a following formula (3a), and an activation function f₂ is a ReLU (ramp function) such as a following formula (3b).

f₁(x)=f₃(x)=f₄(x)=f₅(x)=x (3a)

f₂(x)=max(0, x) (3b)

The array Z₆ of the output layer 56 is expressed as a following formula (4).

Z₆=f₅(A₅(f₄(A₄(f₃(A₃(f₂(A₂(f₁(A₁X₁+B₁))+B₂))+B₃))+B₄))+B₅) (4)

In the present embodiment, the learning section 23 learns the model parameters by using a gradient method such that an error L calculated based on an error function expressed as a following formula (5) is minimized.

[Formula 1]

L=|W_{Y}·(Y−\tilde{Y})+W_{X}·(X−\tilde{X})|² (5)

In the formula (5), “·” denotes an inner product of matrices. The arrays X, Y, W_{X}, W_{Y}, X˜, Y˜ are expressed as follows.

X=(z_{1,9} z_{1,10} z_{1,11} z_{1,12})^{T}

Y=(z_{1,1} z_{1,2} z_{1,3} z_{1,4})^{T}

W_{X}=(z_{1,13} z_{1,14} z_{1,15} z_{1,16})^{T}

W_{Y}=(z_{1,5} z_{1,6} z_{1,7} z_{1,8})^{T}

X˜=(z_{6,5} z_{6,6} z_{6,7} z_{6,8})^{T}

Y˜=(z_{6,1} z_{6,2} z_{6,3} z_{6,4})^{T}

As shown in the formula (5), the arrays W_{X}, W_{Y} representing the missing data statuses are inserted in the error function. Thus, the values substituted into the missing-value portions are not factored in the error L. In other words, the error L is calculated based on the non-missing-value portions.

For the gradient method, for example, stochastic gradient descent such as Adam, SGD, or AdaDelta can be used. Not limited to the gradient method, another scheme may be used.

Regarding the prediction model according to the present embodiment, a configuration of layers, a size of each layer, and activation functions are not limited to the examples described above. As other specific examples, an activation function may be a step function, a sigmoid function, a polynomial formula, an absolute value, maxout, softsign, softplus, or the like. The prediction model is not limited to a feedforward neural network as shown in FIG. 2, but may be a recurrent neural network typified by Long short-term memory (LSTM).

In the example in FIG. 2, the intermediate layer 54 includes four nodes that are affected by both the health action data and the biomarker data. The intermediate layer 54 may further include one or more (for example, four) nodes that are affected by the biomarker data but are not affected by the health action data, and/or one or more (for example, four) nodes that are affected by the health action data but are not affected by the biomarker data. The nodes that are affected by the biomarker data but are not affected by the health action data are, for example, nodes connected, on the input side, only to four upper-side nodes of the intermediate layer 53. The nodes that are affected by the health action data but are not affected by the biomarker data are, for example, nodes connected, on the input side, only to four lower-side nodes of the intermediate layer 53. Output of the nodes that can be added to the intermediate layer 54 may be connected, for example, to the nodes of the intermediate layer 55 shown in FIG. 2. Regarding, in particular, the output of the nodes that can be added to the intermediate layer 54, output of the nodes that are affected by the biomarker data but are not affected by the health action data and output of the nodes that are affected by the health action data but are not affected by the biomarker data may be configured as follows, respectively. Specifically, the configuration is made such that the output of the nodes that are affected by the biomarker data but are not affected by the health action data is connected only to nodes that affect the array of the reconstructed biomarker, among the nodes of the intermediate layer 55 shown in FIG. 2. Moreover, the configuration is made such that the output of the nodes that are affected by the health action data but are not affected by the biomarker data are connected only to nodes that affect the array of the reconstructed health action. Alternatively, a configuration may be made such that the output of the nodes that are only affected by the biomarker data is connected only to the nodes that affect the array of the reconstructed health action, and the output of the nodes that are only affected by the health action data is connected only to the nodes that affect the array of the reconstructed biomarker so that a relationship between the input and the output is crossed. The intermediate layer 55 may include a further node (not shown in FIG. 2), and the output of the nodes that can be added to the intermediate layer 54 may be connected to the further node of the intermediate layer 55. The further node of the intermediate layer 55 may be connected, or need not be connected, to the four nodes of the intermediate layer 54 shown in FIG. 2. By adding the nodes to the intermediate layer 54, accuracy in data prediction using the prediction model can be enhanced.

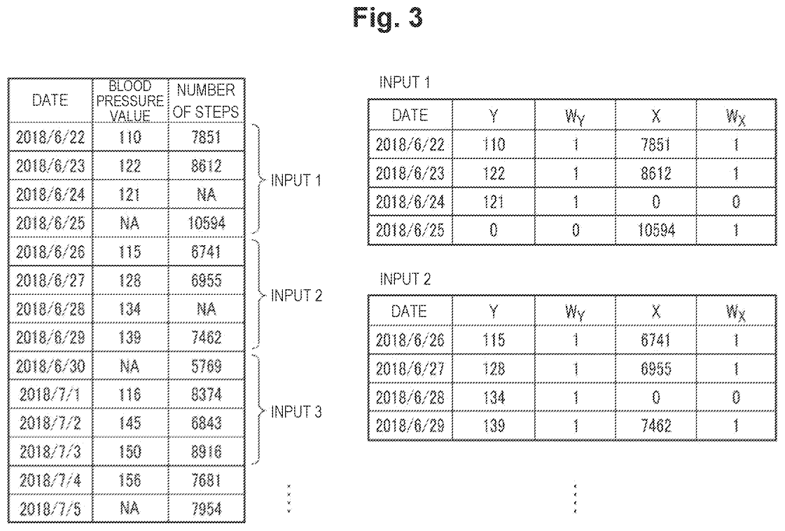

An example of a method for generating input data for learning will be described with reference to FIG. 3. FIG. 3 shows the biomarker data and the health action data stored in the data storage section 31, and input data for learning generated based on the biomarker data and the health action data. Here, the biomarker data is time-series data on measured values of blood pressure (systolic blood pressure), and the health action data is time-series data on measured values of the number of steps. In the example shown in FIG. 3, in the biomarker data, data on June 25, June 30, and July 5 are missing. In the health action data, data on June 24 and June 28 are missing.

The prediction model having the architecture shown in FIG. 2 requires input data including biomarker data and health action data for four days. The input data generation section 22 generates input data by dividing the entire data into four-day data subsets. Specifically, the input data generation section 22 generates a plurality of subsets of input data by generating input data from data on June 22 to June 25, generating input data from data on June 26 to June 29, generating input data from data on June 30 to July 3, and so on.

In FIG. 3, “NA” indicates a missing value. In each input data, a value “0” is substituted into each missing-value portion (each element corresponding to a missing value). Instead of the value “0”, another value such as a mean value or a median value may be substituted for each missing value.

Since measured values of blood pressure are obtained on June 22 to June 24, corresponding elements of the array W_{Y} are set to the value “1”, and since the biomarker data is missing (no measured value of blood pressure is obtained) on June 25, a corresponding element of the array W_{Y} is set to the value “0”. Similarly, since measured values of the number of steps are obtained on June 22, June 23, and June 25, corresponding elements of the array W_{X} are set to the value “1”, and since the health action data is missing on June 24, a corresponding element of the array W_{X} is set to the value “0”.

The following arrays X, Y, W_{X}, W_{Y} are obtained from the four-day data on June 22 to June 25.

X=(7851 8612 0 10594)^{T}

Y=(110 122 121 0)^{T}

W_{X}=(1 1 0 1)^{T}

W_{Y}=(1 1 1 0)^{T}

The array Z₁ as input data is obtained as follows.

Z₁=(110 122 121 0 1 1 1 0 7851 8612 0 10594 1 1 0 1)^{T}

Similarly, from the four-day data on June 26 to June 29, the array Z₁ as input data is obtained as follows.

Z₁=(115 128 134 139 1 1 1 1 6741 6955 0 7462 1 1 0 1)^{T}

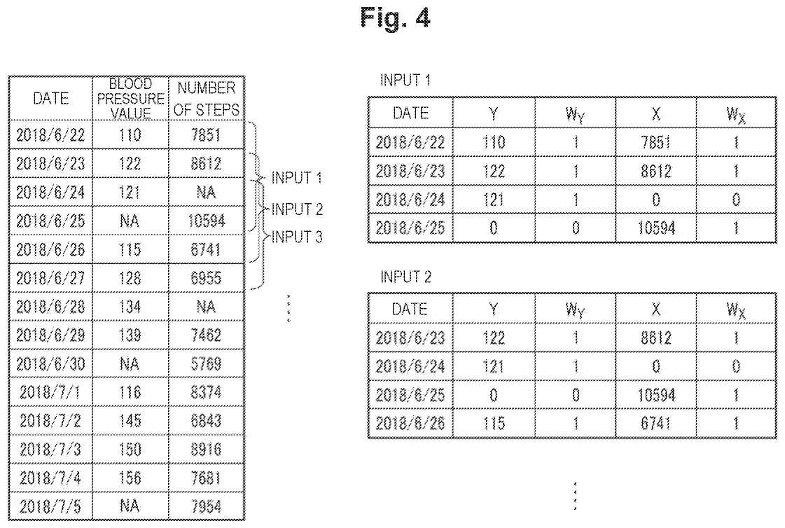

The method for generating input data shown in FIG. 3 is only an example. As shown in FIG. 4, the input data generation section 22 may generate input data by extracting four-day data while sliding a four-day window one day by one day. Specifically, many subsets of input data may be generated by generating one subset of input data from four-day data on June 22 to June 25, generating one subset of input data from four-day data on June 23 to June 26, generating one subset of input data from four-day data on June 24 to June 27, and so on.

One or some, or all, of the functions of the data processing apparatus 1 may be implemented by a hardware circuit such as an ASIC (Application Specific Integrated Circuit) or an FPGA (Field-Programmable Gate Array). It is possible that the storage unit 30 does not include at least one of the data storage section 31 and the model storage section 32, and the at least one of the data storage section 31 and the model storage section 32 may be provided, for example, in a storage apparatus on the communication network NW.

In the present embodiment, both a learning device that performs learning processing and a prediction device that performs prediction processing are provided in the data processing apparatus 1. However, the learning device and the prediction device may be implemented as separate devices.

[Operation]

Examples of operation of the data processing apparatus 1 having the above-described configuration will be described.

(Learning Processing)

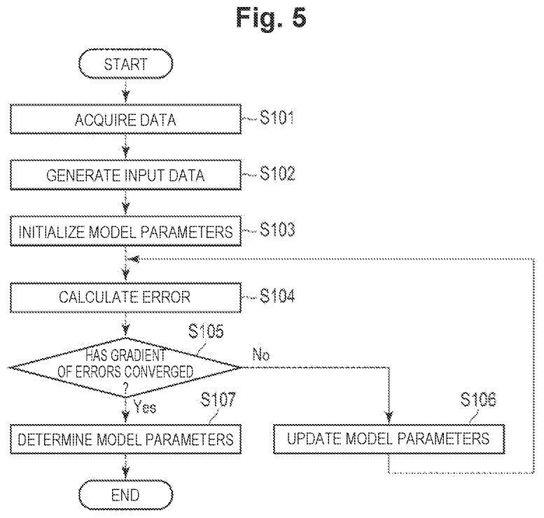

Learning processing according to the present embodiment will be described with reference to FIG. 5. FIG. 5 illustrates the learning processing performed by the data processing apparatus 1 shown in FIG. 1.

First, the data reception section 21 acquires health action data and biomarker data for learning from an external apparatus via the input/output interface unit 10 (step S101). For example, the data reception section 21 acquires the health action data and the biomarker data that have been recorded for a long time as shown in FIG. 3.

The input data generation section 22 generates input data, based on the health action data and the biomarker data acquired by the data reception section 21 (step S102). Specifically, the input data generation section 22 extracts health action data and biomarker data for a number of days according to the number of input dimensions of the prediction model, from the health action data and the biomarker data acquired by the data reception section 21. The input data generation section 22 generates auxiliary data, based on a missing data status in each of the extracted health action data and biomarker data. The input data generation section 22 generates the input data by combining the extracted health action data and biomarker data with the generated auxiliary data. A plurality of subsets of input data are generated by repeating such processing. For example, input data (input 1, input 2, . . . ) as shown in FIG. 3 is generated.

The learning section 23 initializes the model parameters of the prediction model (step S103). The model parameters include weight parameters (specifically, the matrices A₁, A₂, A₃, A₄, A₅) and bias parameters (specifically, the arrays B₁, B₂, B₃, B₄, B₅). For example, the learning section 23 substitutes random values into the weight parameters and the bias parameters.

Next, the learning section 23 learns the model parameters of the prediction model by using the input data generated by the input data generation section 22 (steps S104 to S106).

Specifically, the learning section 23 acquires output data outputted from the prediction model when each input data is inputted into the prediction model. The learning section 23 calculates an error between each of the health action data and the biomarker data included in the input data and the output data, according to the auxiliary data generated by the input data generation section 22 (step S104). The error is calculated, for example, in accordance with the error function shown above as the formula (5).

The learning section 23 determines whether or not a gradient of errors has converged (step S105). When the gradient of errors has not converged, the learning section 23 updates the model parameters in accordance with the gradient method (step S106). The learning section 23 then calculates an error by using the prediction model including the updated model parameters (step S104).

When the gradient of errors has converged as a result of repetition of the processing shown in step S104 and step S106, the learning section 23 determines the current model parameters as the model parameters to be used in prediction (step S107), and stores the current model parameters in the model storage section 32.

(Estimation Processing)

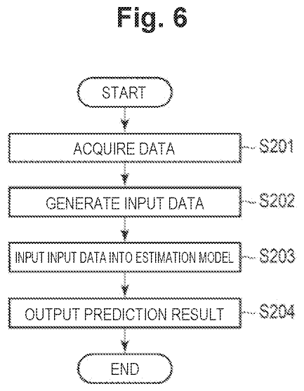

Prediction processing according to the present embodiment will be described with reference to FIG. 6. FIG. 6 illustrates the estimation processing performed by the data processing apparatus 1 shown in FIG. 1.

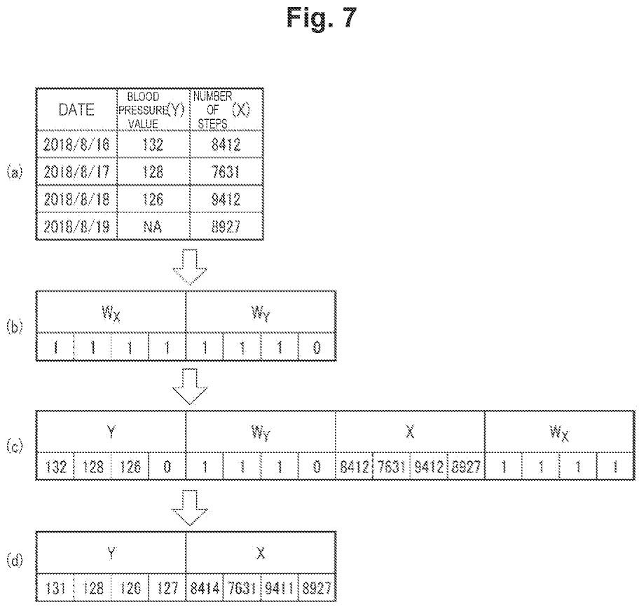

In step S201 in FIG. 6, the data reception section 21 acquires health action data and biomarker data for prediction processing from an external apparatus via the input/output interface unit 10. FIG. 7(a) shows an example of the health action data and the biomarker data for prediction processing. In the example in FIG. 7(a), a portion of the health action data is missing.

In step S202 in FIG. 6, the input data generation section 22 generates input data, based on the health action data and the biomarker data acquired by the data reception section 21. Specifically, the input data generation section 22 generates auxiliary data related to the health action data based on a missing data status in the health action data, and generates auxiliary data related to the biomarker data based on a missing data status in the biomarker data. For example, auxiliary data (arrays W_{X}, W_{Y}) shown in FIG. 7(b) is generated based on the health action data (array X) and the biomarker data (array Y) shown in FIG. 7(a). Subsequently, the input data generation section 22 generates the input data by combining the generated auxiliary data with the health action data and the biomarker data acquired by the data reception section 21. For example, input data shown in FIG. 7(c) is obtained by combining the health action data and the biomarker data shown in FIG. 7(a) with the auxiliary data shown in FIG. 7(b).

In step S203 in FIG. 6, the prediction section 24 reads model parameters from the model storage section 32, sets the read model parameters in the prediction model, and inputs the input data generated by the input data generation section 22 into the prediction model. Thus, the prediction section 24 acquires output data in which a predicted value is interpolated in the missing-value portion. For example, output data shown in FIG. 7(d) is obtained by inputting the input data shown in FIG. 7(c) into the prediction model.

In step S204 in FIG. 6, the output control section 25 outputs the output data acquired by the prediction section 24 as a prediction result. As shown in FIGS. 7(c) and 7(d), an error may occur between the array X and the array X˜ and between the array Y and the array Y˜, in other portions than the missing-value portion. For example, although a first element of the array Y is 132, a first element of the array Y˜ is 131. Accordingly, the output control section 25 may output the biomarker data acquired by the data reception section 21 in which the predicted value corresponding to the missing value is substituted, as a prediction result.

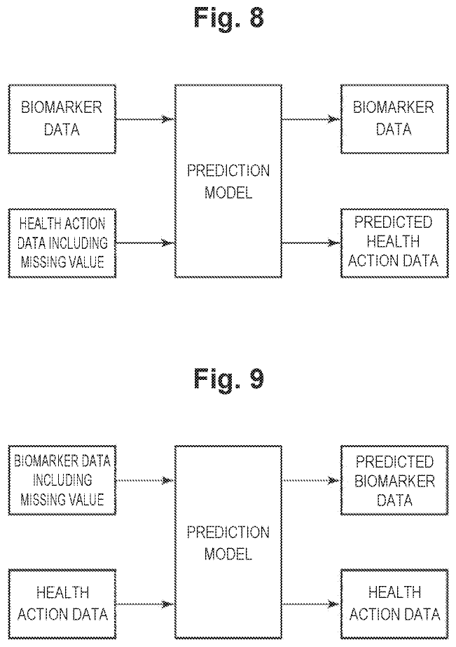

According to the example described with reference to FIGS. 7(a) to 7(d), the biomarker data includes no missing value, a portion of the health action data is missing, and the predicted value corresponding to the missing value is obtained, as shown in FIG. 8. In contrast, when the health action data includes no missing value and a portion of the biomarker data is missing, a predicted value corresponding to the missing value can also be obtained, as shown in FIG. 9. When both the health action data and the biomarker data include missing values, predicted values corresponding to the missing values can also be obtained.

The learning processing shown in FIG. 5 and the prediction processing shown in FIG. 6 are only examples, and a procedure and contents of each processing can be changed as appropriate. For example, in step S204 in FIG. 6, the prediction section 24 may acquire data (array Z₄) outputted from the intermediate layer 54 of the prediction model. Such data represents an abstracted feature representing a relationship between the health action and the biomarker. The data can be used as an input into a learning machine that is different from the prediction model. For the learning machine, for example, a classifier such as logistic regression, a port vector machine, or a random forest, or a regression model using multiple regression analysis or a regression tree can be used.

[Effects]

The data processing apparatus 1 according to the present embodiment generates input data in which the health action data and the biomarker data are combined with the auxiliary data based on the respective missing data statuses in the health action data and the biomarker data. The data processing apparatus 1 according to the present embodiment learns the model parameters of the prediction model such that an error between output data calculated according to the auxiliary data and each of the health action data and the biomarker data is minimized. Here, the output data is data outputted from the prediction model when the input data is inputted into the prediction model.

In the above-described configuration, an error is calculated, with an effect of missing data excluded. Thus, the model parameters of the prediction model that models a relationship between the health action data and the biomarker data can be effectively learned by using data including a missing value.

Further, by using the prediction model in which the model parameters learned as described above are set, the data processing apparatus 1 can obtain a predicted value corresponding to a missing value included in at least one of the health action data and the biomarker data.

The prediction processing can also be used for other purposes than prediction of a value corresponding to a missing value occurring due to non-performance of measurement or the like. For example, the prediction processing can be used to find a health action required to obtain data (for example, data indicating desired changes over time in blood pressure) that is tentatively set as biomarker data. Thus, a target of the health action can be set.

<Other Embodiments>

Note that the present invention is not limited to the above-described embodiment.

In the above-described embodiment, the auxiliary data is generated based on the respective missing data statuses in both the health action data and the biomarker data. A method for generating the auxiliary data is not limited to the method described in the embodiment. The auxiliary data may be generated based on the missing data status in one of the health action data and the biomarker data.

For example, it is assumed that the biomarker data is acquired through an examination at a hospital, and the health action data is acquired by a wearable device. In such a case, the biomarker data is acquired only when the user visits the hospital. Accordingly, a missing-value rate in the biomarker data is larger than a missing-value rate in the health action data. Such bias in missing values can cause an error in a result of analysis of the health-marker data and the health action data.

In another embodiment, the input data generation section 22 may calculate a degree of missing values in each of the health action data and the biomarker data, may select data with the higher degree of missing values between the health action data and the biomarker data, and may generate auxiliary data based on the missing data status in the selected data. In the present embodiment, the degree of missing values is the number of elements with a value of zero in the array. Instead, the degree of missing values may be, for example, a proportion of the number of elements with a value of zero to the number of all elements in the array.

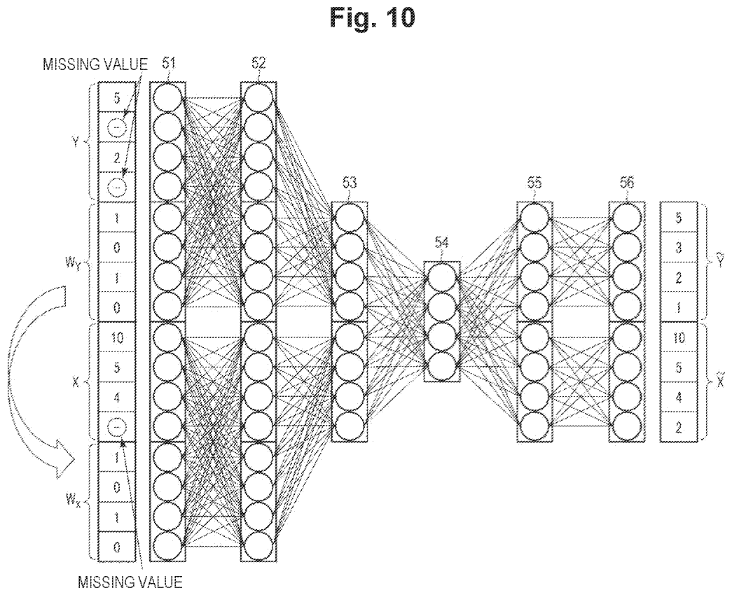

In an example shown in FIG. 10, the degree of missing values in the biomarker data is 2, and the degree of missing values in the health action data is 1. The input data generation section 22 generates auxiliary data (array W_{Y}) related to the biomarker data, based on the missing data status in the biomarker data with the higher degree of missing values, and generates auxiliary data (array W_{X}) related to the health action data by duplicating the auxiliary data related to the biomarker data. In other words, the auxiliary data related to the health action data is set to be the same as the auxiliary data related to the biomarker data. In such a case, an evaluation function is expressed as a following formula (6).

[Formula 2]

L=|W_{Y}·(Y−\tilde{Y})+W_{Y}·(X−\tilde{X})|² (6)

According to the present embodiment, for example, when there is bias in missing values between the health action data and the biomarker data, a relationship between the health action and the biomarker can be effectively learned.

In another embodiment, the input data generation section 22 may generate auxiliary data, based on the missing data status in one of the health action data and the biomarker data, which is selected based on a degree of importance of each of the health action and the biomarker. The degree of importance of each of the health action and the biomarker may be set, for example, by an operator such as a doctor. For example, when the degree of importance of the biomarker is higher than the degree of importance of the health action, the input data generation section 22 generates auxiliary data (array W_{Y}) related to the biomarker data based on the missing data status in the biomarker data, and generates auxiliary data (array W_{X}) related to the health action data by duplicating the auxiliary data related to the biomarker data. In such a case, an evaluation function is expressed as the formula (6).

According to the present embodiment, learning is performed, for example, with emphasis placed on data with a higher degree of importance. Thus, model parameters can be obtained that enhance accuracy in prediction for the data with the higher degree of importance.

There may be a time lag in a relationship between the health action and the biomarker. For example, there may be a time difference between when the health action takes place and when an effect of the health action is reflected on the biomarker. In other words, there are some cases where a result of the most recent health action is not immediately reflected on the biomarker, but an effect of the health action appears in the biomarker after a certain period of time.

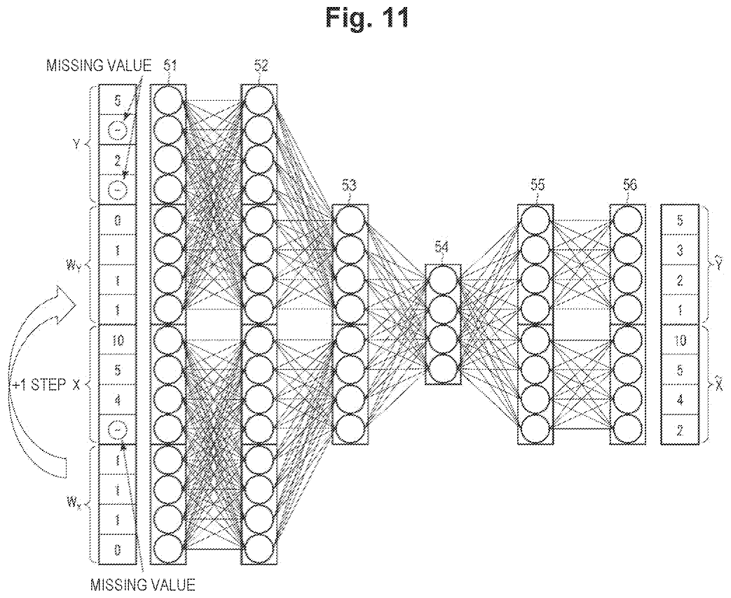

In another embodiment, a temporal relationship between the health action and the biomarker is taken into consideration. In the present embodiment, the input data generation section 22 generates auxiliary data (array W_{X}) related to the action indicator data based on the missing data status in the health action data, and generates auxiliary data (array W_{Y}) related to the biomarker data based on the auxiliary data related to the health action data and on the temporal relationship. A step after which an effect of the health action appears in the biomarker is set. The step corresponds to a time difference between elements in the input array. Here, a case will be considered in which an effect of the health action appears in the biomarker one day (one step) later. It is assumed that the elements in the array are arranged in order of dates. As shown in FIG. 11, an array is created by shifting the elements in the array W_{X} by one step, and a value “0” is substituted into a first element of the created array. The obtained array is set as the array W_{Y}. Such a procedure can be implemented by recursively performing processing of shifting by one step by using a program. The array W_{Y} may be calculated through a matrix operation using a matrix H shown below.

$$H = ( \begin{matrix}0 & 0 & 0 & 0 \\ 1 & 0 & 0 & 0 \\ 0 & 1 & 0 & 0 \\ 0 & 0 & 1 & 0\end{matrix} ) \qquad [ Formula 3 ]$$

For example, when W_{X}=(1 0 1 0)^{T}, W_{Y} can be calculated as follows.

$${W}_{Y} = H {W}_{x} = ( \begin{matrix}0 & 0 & 0 & 0 \\ 1 & 0 & 0 & 0 \\ 0 & 1 & 0 & 0 \\ 0 & 0 & 1 & 0\end{matrix} ) ( \begin{matrix}1 \\ 0 \\ 1 \\ 0\end{matrix} ) = ( \begin{matrix}0 \\ 1 \\ 0 \\ 1\end{matrix} ) \qquad [ Formula 4 ]$$

In the present embodiment, an evaluation function is expressed as a following formula (7).

[Formula 5]

L=|(HW_{X})·(Y−\tilde{Y})+W_{X}·(X−\tilde{X})² (7)

According to the present embodiment, since a time lag between the health action and the biomarker is taken into consideration, a relationship between the health action and the biomarker can be modeled more accurately.

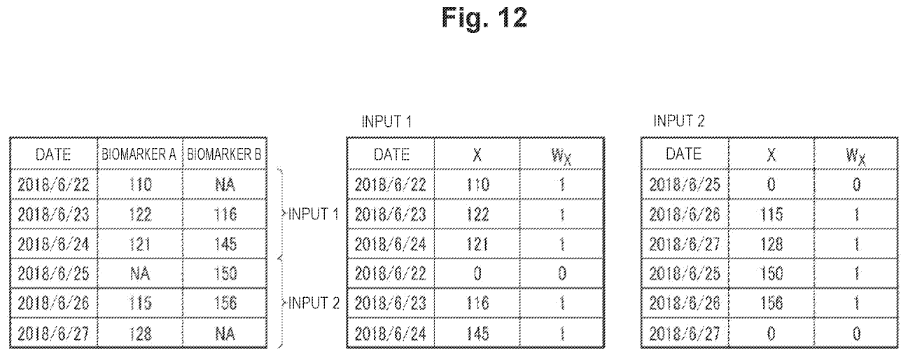

Although a case is described in the embodiments where a relationship between the two phenomena, which are the health action and the biomarker, is learned, the data processing apparatus 1 can also learn a relationship among three or more phenomena. For example, when biomarker data related to two types of biomarkers is acquired as shown in FIG. 12, an array X is generated by extracting biomarker data for a predetermined number of days, on each of the two types of biomarkers. In the example in FIG. 12, biomarker data for three days is extracted. In such a case, data for three days is also extracted with respect to the health action data. Note that the data may be extracted while sliding a three-day window one day by one day as described with reference to FIG. 4.

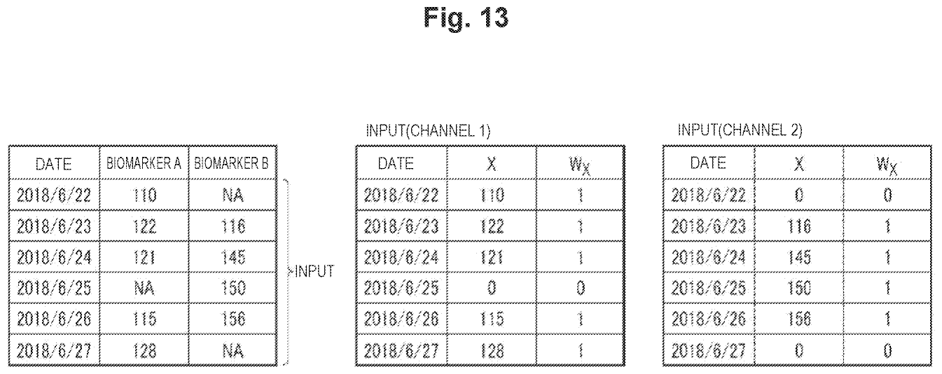

When a plurality of types of data exist, each of the plurality of types of data may be assigned to and inputted into an input channel as shown in FIG. 13. Such a configuration can be implemented by using a general scheme used when image data is inputted into a neural network in cases where one pixel has three types of information such as an RGB image.

In the above-described embodiments, examples in which time-series data is handled are described. However, the embodiments are also applicable to other data than time-series data. For example, data on temperatures recorded at each observation point may be handled, and image data may be handled. In a case of data represented by a two-dimensional array such as image data, input data may be generated by extracting information from each line and combining the respective information from the lines, as in the case where a plurality of types of data exist.

In short, the present invention is not limited to the embodiments in unchanged form, but can be implemented by modifying the constituent elements without departing from the gist of the invention in an implementation phase. Various inventions can be made by combining a plurality of constituent elements disclosed in the embodiments as appropriate. For example, one or some constituent elements may be eliminated from all the constituent elements shown in the embodiments. Constituent elements in different embodiments may be combined as appropriate.

### REFERENCE SIGNS LIST

1 Data processing apparatus

10 Input/output interface unit

20 Control unit

21 Data reception section

22 Input data generation section

23 Learning section

24 Prediction section

25 Output control section

30 Storage unit

31 Data storage section

32 Model storage section

51 Input layer

52 to 55 Intermediate layer

56 Output layer

1. A data processing apparatus, comprising:
a processor; and
a storage medium having computer program instructions stored thereon, when executed by the processor, perform:
a first generation section that generates first input data in which first data related to a first phenomenon and second data related to a second phenomenon that is relevant to the first phenomenon are combined with first auxiliary data that is based on a missing data status in at least one of the first data and the second data; and
a learning section that learns a model parameter of a prediction model, based on an error according to the first auxiliary data between output data outputted from the prediction model when the first input data is inputted into the prediction model, and each of the first data and the second data.

2. The data processing apparatus according to claim 1, wherein the first generation section generates the first auxiliary data including auxiliary data that is based on the missing data status in the first data and auxiliary data that is based on the missing data status in the second data.

3. The data processing apparatus according to claim 1, wherein the first generation section calculates a degree of missing data in each of the first data and the second data, selects data with the higher degree of missing data between the first data and the second data, and generates the first auxiliary data based on the missing data status in the selected data.

4. The data processing apparatus according to claim 1, wherein the first generation section generates the first auxiliary data, based on the missing data status in predetermined data between the first data and the second data.

5. The data processing apparatus according to claim 1, wherein the first generation section generates the first auxiliary data, based on the missing data status in predetermined data between the first data and the second data, and on a temporal relationship between the first phenomenon and the second phenomenon.

6. The data processing apparatus according to claim 1,
wherein the prediction model is a neural network including an input layer, at least one intermediate layer, and an output layer, and one of the at least one intermediate layer includes a node that is affected by both the first data and the second data, and at least one of a node that is affected by the first data but is not affected by the second data and a node that is affected by the second data but is not affected by the first data.

7. The data processing apparatus according to claim 1, further comprising:
a second generation section that generates second input data in which third data related to the first phenomenon and fourth data related to the second phenomenon are combined with second auxiliary data that is based on a missing data status in at least one of the third data and the fourth data; and
a prediction section that inputs the second input data into the prediction model in which the learned model parameter is set, and obtains a predicted value corresponding to a missing value included in at least one of the third data and the fourth data.

8. The data processing apparatus according to claim 1, further comprising:
a second generation section that generates second input data in which third data related to the first phenomenon and fourth data related to the second phenomenon are combined with second auxiliary data that is based on a missing data status in at least one of the third data and the fourth data; and
a prediction section that inputs the second input data into the prediction model in which the learned model parameter is set, and obtains data outputted from an intermediate layer of the prediction model.

9. A data processing method, comprising:
generating input data in which first data related to a first phenomenon and second data related to a second phenomenon that is relevant to the first phenomenon are combined with auxiliary data that is based on a missing data status in at least one of the first data and the second data; and
learning a model parameter of a prediction model, based on an error according to the auxiliary data between output data outputted from the prediction model when the input data is inputted into the prediction model, and each of the first data and the second data.

10. A non-transitory computer-readable medium having computer-executable instructions that, upon execution of the instructions by a processor of a computer, cause the computer to function as the data processing apparatus according to claim 1.
